(19) United States
(12) Patent Application Publication
(10) Pub. No.: US 2007/0209587 A1
(43) Pub. Date: Sep. 13, 2007

(54) Dosing Device And Apparatus For Applying Adhesives To At Least One Dosing Device, And Substrate Web

(76) Inventors: Waldemar Kiener, Lauchheim (DE); Johann Rein, Bopfingen (DE)

Correspondence Address: KRIEGSMAN & KRIEGSMAN, 30 TURNPIKE ROAD, SUITE 9, SOUTHBOROUGH, MA, 01772, US

(21) Appl. No.: 10/580,109

(22) PCT Filed: Nov. 4, 2004
(86) PCT No.: PCT/EP04/12445

§ 371 Date: Mar. 14, 2007

(30) Foreign Application Priority Data
Nov. 19, 2003 (DE) 103 54 153.5

(51) Int. Cl. B05C 11/00; B05C 11/02

(52) U.S. Cl. 118/712; 118/110

(57) ABSTRACT

The invention relates to an apparatus for coating at least one substrate web (19) or laminating at least one substrate web (22) onto a substrate web (19) that is coated with adhesives (21) so as to form a laminate (24). Said apparatus comprises a dosing device that is assigned to an application roller (16) used for applying adhesive (21) as well as a counterpressure roller (17) which is allocated to the application roller (16) and between which the at least one substrate web (19) is fed in order to apply the adhesive (21). The dosing device (14) is disposed so as to be movable relative to the application roller (16) in order to adjust a width of the dosing gap (28). The inventive apparatus is characterized in that the dosing device (14) encompasses at least two different areas (34, 37) which can be selectively assigned to a closing gap (28) in order to apply adhesive (21).

The invention relates to a dosing device and an apparatus for applying adhesives to at least one substrate web.

From DE 296 12 052 U1 is known a device for wet coating, in particular of printed boards, with varnish. This device comprises an application roller and a dosing roller that operate jointly and create a varnish sump between their upper sections. For application of the varnish, arc-shaped wiper edges on a wiper are provided that are arranged on a separate doctor blade facility and can be made to approach the application roller by an approaching motion in X and Y direction.

The doctor blade facility is positioned fixed such as to be allocated towards the application roller such that a selection of multiple ranges of action for adjustment of the application is not feasible.

From DE 101 57 366 A1 is known a device for laminating or coating a substrate, in which a multi-roller system comprised of a dosing roller, an application roller, and a counterpressure roller is provided. An adhesive is applied to the application roller by means of the dosing roller. The adhesive film on the application roller is transferred to a substrate web that is supplied to a gap created between the application roller and the counterpressure roller. This coated substrate web can be conveyed off for further processing or, for example, laminated to a further substrate web by a laminating roller that is allocated to the counterpressure roller. For adjustment of the thickness of the adhesive film, the dosing roller is provided to be mobile with respect to the application roller. This allows the thickness of the adhesive film to be applied to be adjusted.

The requirements regarding the flexibility of devices for coating or laminating of substrate webs are steadily increasing. These requirements are determined by the different structures of the materials to be coated or laminated to a further substrate web. Moreover, there is also a need for adjustment of the application of adhesive and of the type of the adhesive to the structures of the material of at least one substrate web in order to attain the desired coating or a secure connection between at least two substrate layers.

The invention is therefore based on the object to create a dosing device and a device for applying adhesive to at least one substrate web that provide for rapid and simple adjustment and re-assembly at least for different types of adhesive or different application structures of the adhesive.

This object is met according to the invention by the dosing device according to the features of claim 1 and a device for applying adhesive to at least one substrate web according to claim 17.

The further development of the dosing device according to the invention such that it comprises at least two areas that differ from each other and optionally can be made allocated to a dosing gap in order to create a dosing gap jointly with the dosing gap provides for rapid and easy adjustment of the dosing device with respect to the application roller in order to apply different application structures to the at least one substrate web and/or different adhesives to the application roller. Since the dosing device comprises at least two areas that differ from each other, an adjustment or re-assembly can be carried out without having to exchange the entire dosing device. This minimizes the assembly times substantially. Simultaneously, expenditures related to the stock-keeping of multiple dosing devices for the processing of different adhesives and/or the application of application structures are dispensed with.

The dosing device according to the invention facilitates, for example, full-surface coating, full-surface coating and surface structures, open-pore coatings such as, for example, so-called open-coating structures, and open-pore coatings with surface structures. This significantly improves the flexibility of the dosing device and a multitude of different substrate webs or multiple substrate webs arranged next to each other can be coated by the adhesive specifically provided for this purpose and/or can be laminated to further substrate webs.

According to an advantageous further development of the dosing device, the invention provides that rotation of the dosing device, preferably about its longitudinal axis, allows at least two areas to be adjusted optionally and allocated to the dosing gap. This provides for rapid re-assembly of the dosing device. This arrangement of the dosing device such as to be capable of rotation can be made independent of the adjustment of a dosing gap from the dosing device to the application roller. It is advantageous to mutually match both the width of the dosing gap and the allocation of the at least one area of the dosing device with respect to the dosing gap.

For application of the adhesive to the application roller, the dosing device advantageously comprises at least one area that is provided in the form of a doctor blade. The doctor blade protrudes at least partly into the dosing gap and allows various adjustments in the dosing gap.

Advantageous, the dosing device comprises at least one further area that is provided in the form of an external surface area, in particular by means of a circumferential surface or a circumferential wall section. Preferably, this circumferential surface is provided in the form of at least a circle segment such that upon arrangement of this area towards the application roller a dosing gap is formed by two circle segments residing opposite from each other.

According to another advantageous development, the invention provides that at least one smooth or structured action surface is optionally provided on one edge of the doctor blade, on the external surface area, and on the surface of the application roller. This allows for the creation of a full-surface adhesive film and different surface structures. For example, the structure of the application roller can be designed to allow the application of individual dots of adhesives for an open coating structure. By allocating a smooth action surface of the dosing device, the dot-shaped structure can be provided, for example, on an adhesive film of variable thickness. Alternatively, a structured action surface can be provided on the at least one further area such that, for example, the structured action surface of the at least one further action area is superimposed on the dot-shaped structuring of the application roller. Depending on the gap width setting, an adhesive film may be provided in between. This applies analogously to the at least one area that preferably is provided in the form of a doctor blade. The doctor blade can comprise a continuous wiper edge or a structured wiper edge or sections of structured or continuous wiper edge such that various application structures of the adhesive can be applied to the application roller. Any combination of the individual smooth or structured action surfaces on the components of the dosing gap that are allocated to each other are feasible. Moreover, multiple areas differing from each other can be provided on the dosing device such as, for example, a smooth or structured action surface on the outer circumference of the dosing device and/or a doctor blade with a continuous wiper edge and/or a doctor blade with another structured wiper edge such that five different adjustments with respect to the application roller are feasible in this exemplary embodiment. The number of different action surfaces and/or areas is not limited to this example.

According to an advantageous development, the invention provides for the rotation speeds of application roller and counter roller to be equal or unequal. The rotation speed of the application roller and the rotation speed of the counterpressure roller can be adjusted to be either equal or unequal (speed difference). This can provide for further structuring in the application of the adhesive film and/or adhesive to the at least one substrate web. If the rotation speeds are equal, the application structure applied to the application roller is transferred identically or nearly identically to the at least one substrate web. In the presence of a difference in speeds, in which case the counterpressure roller preferably rotates faster than the application roller, smoothing of the application structure provided on the application roller is facilitated. The larger the difference in rotation speeds, the higher is the degree of smoothing of the structure and the thickness of the adhesive coating can be reduced.

According to an advantageous embodiment, the dosing device can be adjusted by a mechanical or electrical controller facility for adjustment of the various areas with respect to the dosing gap. For example, the dosing device can be controlled by a control of the coating facility such that different application structures can be applied during the coating of a substrate web or laminating of a compound of at least two substrate webs. Accordingly, both the dosing gap and the positioning of the areas can be adjustable. The electrically controlled adjustment facility can advantageously also control the position and orientation of the doctor blade such that it can be changed during a coating or laminating process.

According to a further advantageous development, the invention provides the dosing device to comprise a temperature-controlled facility that is provided inside, outside or inside and outside of the dosing device. This can be provided for the purpose of either cooling or heating in order to allow both cold-setting adhesives and hot-melt adhesives to be processed. For example, one or more cooling and/or heating elements can be provided inside the preferably roller-shaped dosing device in order to temperature-control the dosing device and therefore to temperature-control the adhesive stored between the dosing device and the application roller. Alternatively or in addition, a heating and/or cooling facility acting on the dosing device and/or the adhesive can be provided outside of the dosing device. This can be implemented, for example, by means of radiation or by the temperature-controlled facility direct contacting the dosing device and the stored adhesive.

According to another advantageous development, the dosing device is provided such that, upstream of the application roller in the supply direction of the at least one substrate web, a guiding roller is allocated that is provided for the adjustment of an arc of contact of the substrate web to the application roller. By this means, for example in the coating of a grid-shaped or net-shaped substrate web, it can be made feasible to apply adhesive to one side of this grid- or net-shaped web of material without the adhesive bleeding through the substrate web during passage between the application roller and the counterpressure roller. Thus, this allows for one-sided coating of a grid-shaped or net-shaped substrate web, whereby the gap between the application roller and the counterpressure roller is provided to be such that no adhesive bleeds through and smoothing of the adhesive or adhesive structure is facilitated, if applicable.

The dosing device advantageously comprises an external surface area that is part of the roller circumference. This provides a cost-efficient development of the dosing device.

The dosing device advantageously comprises in the at least one area a doctor blade that is provided in the application roller such that it can be detached. A doctor blade of this type can provide for adjustment of the dosing width in that the doctor blade protrudes to a larger or lesser degree beyond the neighboring circumferential surface of the body.

According to a further advantageous development, the invention provides for the doctor blade to be disposed with respect to the circumferential surface of the application roller at a right angle or at an angle that is larger or smaller than 90°. Accordingly, the doctor blades can be arranged in a neutral, positive or negative position, respectively.

In this context, the neutral position shall be provided, for example, to be the radial alignment with respect to the longitudinal middle axis. A positive doctor blade position with respect to the dosing gap and/or application roller includes an angle position in which the doctor blade assumes the function of a wiper. A negative doctor blade position includes an angle position of the doctor blade with respect to the dosing gap and/or application roller in which a cutting effect is provided. Preferably, the width of the dosing gap can also be adjustable by means of the positioning of the doctor blade in the dosing gap.

The dosing device preferably comprises the at least two areas distributed evenly over the circumference of the at least partly roller-shaped body. This allows maximal spacing to be attained between the areas. Alternatively, the areas can be provided to be divided unequally or arranged at unequal distance.

The dosing device preferably comprises a rapidly detachable connection for receiving at least one doctor blade such that a rapid change thereof is feasible which again reduces the downtimes of the coating facility.

In addition, the invention advantageously provides, with regard to the arrangement of one or more doctor blades, for the respective angle positions to be controlled individually or jointly in a mechanical fashion, for example by a rapidly detachable connection, or in an electrical fashion, for example by a controller mechanism.

The object is met according to the invention by a device for applying adhesives to one or more substrate webs, in particular for laminating, comprising an application roller that is allocated to a counterpressure roller that carries the substrate web opposite of the application roller, and a dosing device according to any of the claims 1 to 16. This increases the flexibility of a coating facility and minimizes the adjustment and re-assembly times. A rapid switch between different coating and laminating tasks can thus be carried out which increases the degree of utilization of the machinery.

The dosing device preferably comprises the at least two areas distributed evenly over the circumference of the at least partly roller-shaped body. This allows maximal spacing to be attained between the areas. Alternatively, the areas can be provided to be divided unequally or arranged at unequal distance.

In addition, the invention advantageously provides, with regard to the arrangement of one or more doctor blades, for the respective angle positions to be controlled individually or jointly in a mechanical fashion, for example by a rapidly detachable connection, or in an electrical fashion, for example by a controller mechanism.

The object is met according to the invention by a device for applying adhesives to one or more substrate webs, in particular for laminating, comprising an application roller that is allocated to a counterpressure roller that carries the substrate web opposite of the application roller, and a dosing device according to any of the claims 1 to 16. This increases the flexibility of a coating facility and minimizes the adjustment and re-assembly times. A rapid switch between different coating and laminating tasks can thus be carried out which increases the degree of utilization of the machinery.

The invention and further advantageous embodiments and developments thereof are described in more detail and illustrated in the following on the basis of the example shown in the drawing. According to the invention, the features that are evident from the description and drawing can be applied individually or in any combination. In the figures:

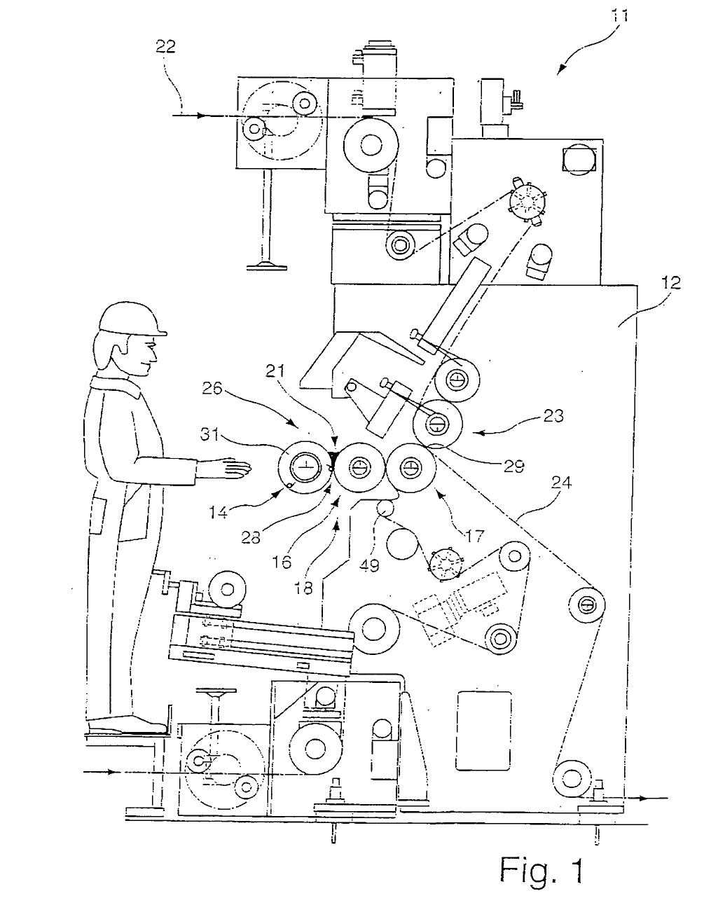

FIG. 1 shows a schematic side view of a multi-purpose coating and laminating facility;

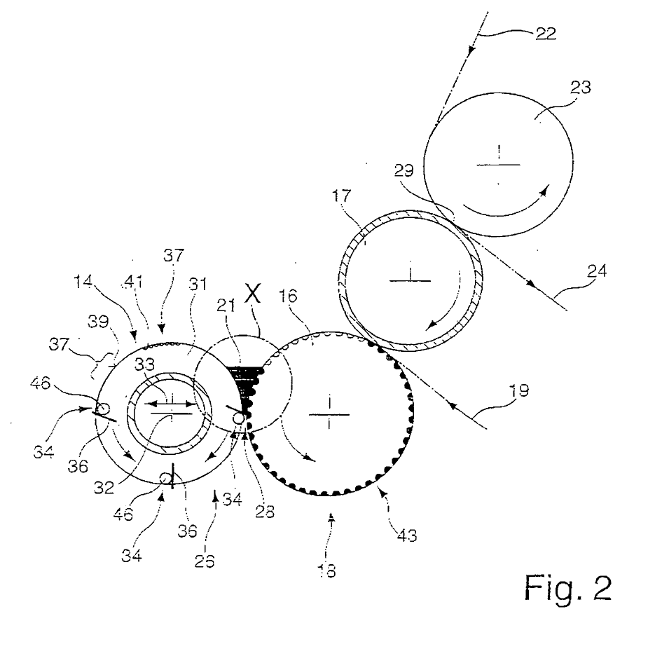

FIG. 2 shows a schematic view of the device for coating or laminating of at least one substrate web;

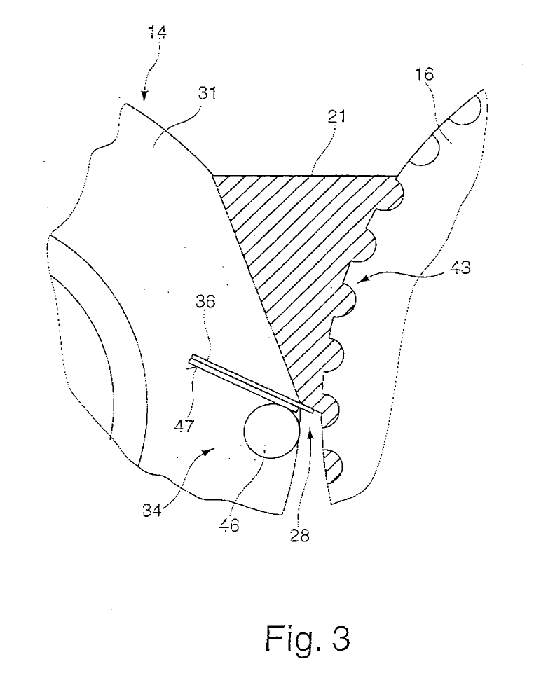

FIG. 3 shows a schematic view of detail X according to FIG. 2;

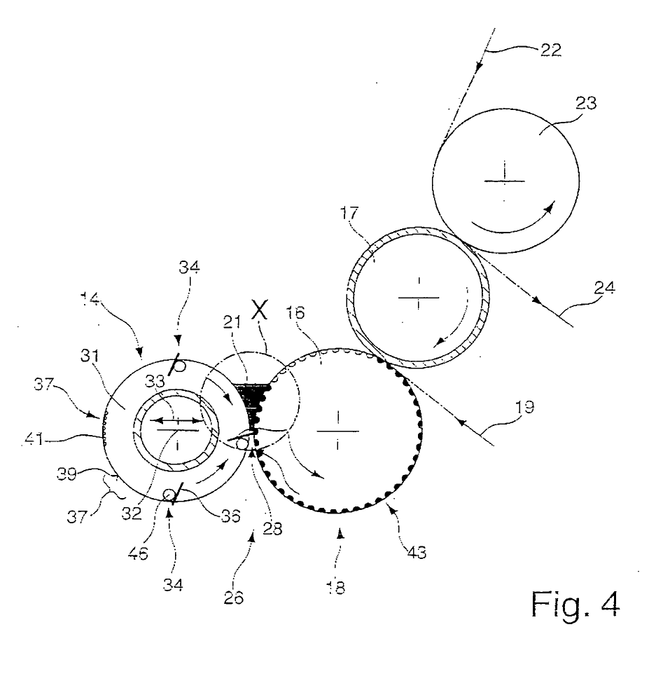

FIG. 4 shows another schematic view of the device with the dosing device for coating and laminating of at least one substrate web in an alternative position;

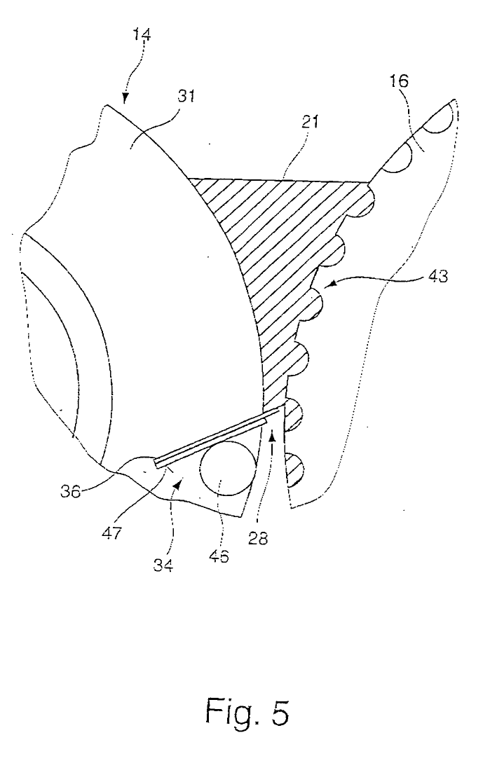

FIG. 5 shows a schematic view of detail Y according to FIG. 4;

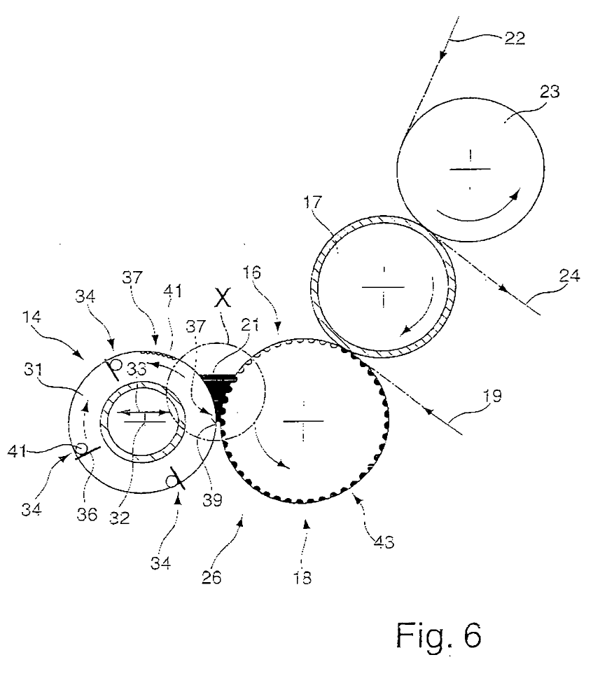

FIG. 6 shows another schematic view of the device with the dosing device for coating and laminating of at least one substrate web in an alternative position;

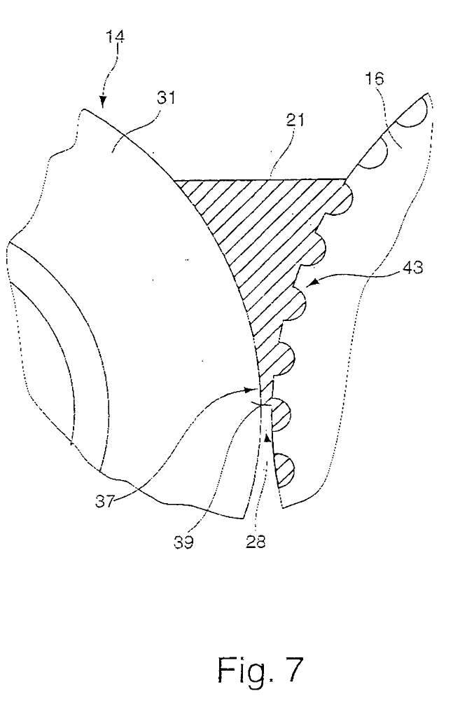

FIG. 7 shows a schematic view of detail Z according to FIG. 6;

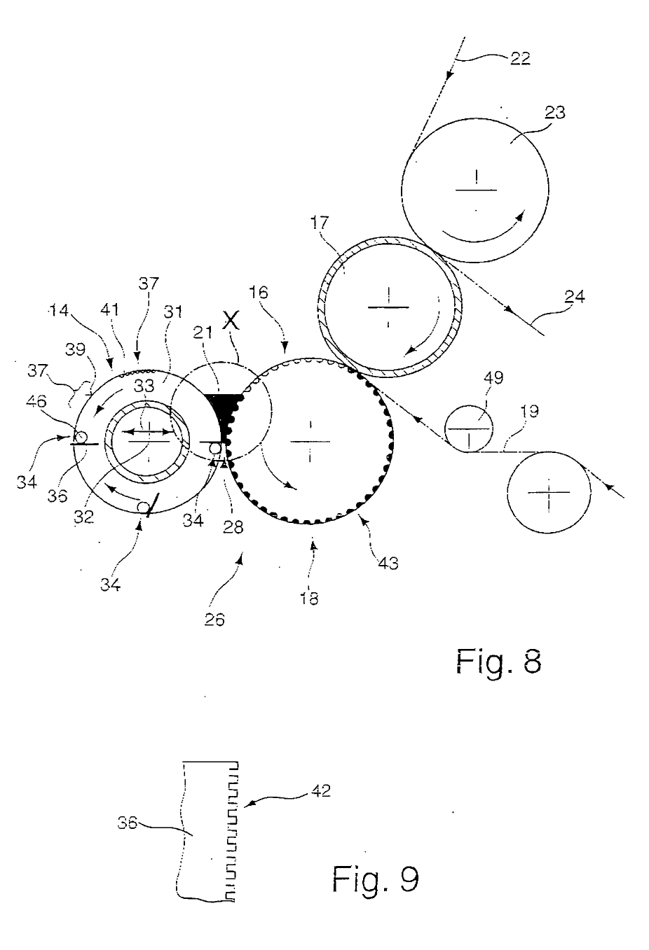

FIG. 8 shows a schematic view of the device with an additional guiding roller; and

FIG. 9 shows a schematic partial view of a doctor blade.

FIG. 1 shows a schematic side view of a coating and laminating facility 11. A dosing device 14, an application roller 16, and a counterpressure roller or driven roller 17 are provided on a machine frame 12. These form a multi-roller system 18 that is used for the coating of substrate webs 19 with an adhesive 21.

In the exemplary embodiment, the substrate web 19 is coated with an adhesive 21. Subsequently, a substrate web 22 is supplied via one or more rollers of a laminating roller 23 that is allocated to the counterpressure roller 17 such that the substrate web 22 is laminated onto the substrate web 19 that is provided with the adhesive 21. The laminate 24 thus formed is then guided out of the coating and laminating facility 11 for further processing or storage. The laminate 24 thus formed can consist of two or more substrate webs or coatings.

FIG. 2 shows a schematic view of a device 26 according to the invention and of the dosing device 14 according to the invention. The dosing device 14 is arranged, for example, at the same level as the application roller 16. Between the dosing device 14 and the application roller 16, a dosing gap 28 is provided through which adhesive 21 is applied to the application roller 16. The adhesive 21 is stored above the dosing gap 28. After the application of the adhesive 21 to the application roller 16, the adhesive 21 is applied to one side of the substrate web 19. For this purpose, a gap to which the substrate web 19 is supplied is provided between the application roller 16 and the counter roller 17. If only a single coating is to be provided, the coated substrate web 19 can be guided off for further processing or storage. In the present exemplary embodiment, the substrate web 19 and its external side that is coated with adhesive 21 is deflected by 180° on the counterpressure roller 17 and the substrate web 22 is supplied such that the laminate 24 is formed in a laminating point 29.

The dosing device 14 stands still during a coating or laminating process. The application roller 16, counterpressure roller 17, and laminating roller 23 are rotated in accordance with the direction indicated by the arrow. These rollers can either be self-driven or driven.

In a wider sense, the term of substrate web shall be understood and comprises woven fabrics, knitted fabrics, wovens, knitted textile fabrics, looped goods, non-woven materials, breathable materials, other fabrics, foam structures, fibrous tissue, fleeces or similar. In this context, it can be not only one-layered material, but also multi-layered compound material or previously manufactured laminate that is to be connected to one or more additional substrate webs to form a new laminate.

Adhesives 21 of various types can be used in coating and laminating facilities 11 of this type. This usually includes thermoplastic adhesives characterized by their property to connect to other materials above a softening or melting point. Moreover, so-called cold-setting adhesives 21 can be provided just as well. The adhesives can also be highly viscous or of low viscosity.

Moreover, for the production of an adhesive coating or a laminate, different application structures of the adhesive 21 are desired. For the application of different application structures, the dosing device 14 and/or the application roller 16 can comprise corresponding structures and surfaces. The dosing device 14 consists at least in part of a roller-shaped body 31 that is supported such as to be capable of rotation about a longitudinal axis 32. Moreover, the longitudinal axis 32 is arranged such as to be movable along the arrow 33 whereby rotation and movability can be superimposed. The movability as indicated by arrow 33 provides for pre-adjustment or adjustment of the gap width of the dosing gap 28. The rotation of the body 31 of the dosing device 14 results in the adjustment of the dosing device 14 to various application structures. In a first area 34 of the dosing device 14 is provided a doctor blade 36 which, according to the exemplary embodiment, is allocated to the dosing gap 28. Moreover, the dosing device 14 comprises two more doctor blades 36 and two further areas 37 that are provided on a circumferential wall or a circumferential wall section 38 of the body 31. The further areas 37 have a smooth surface structure 39 and a structured surface 41. As an example, the dosing device 14 is provided as a roller-shaped body 31. Other body shapes comprising at least one first area 34 and at least one further area 37 are also feasible as body 31.

According to FIG. 2, the application roller 16 comprises a dot-shaped structure 43 that takes up the adhesive 21 and transfers it to the substrate web 19.

The dosing gap 28 and the arrangement of the doctor blade 36 according to detail X in FIG. 2 are shown magnified in FIG. 3. The doctor blade 36 is connected by means of a rapidly detachable connection 46, preferably by means of a lever-actuated eccentric clamp. This detachable connection 46 allows the doctor blade 36 to immerse more or less far into a gap 47 and thus to be adjusted to a corresponding dosing width. In this positive position, the doctor blade 36 has a wiper function. The adhesive 21 is introduced into the structure 43 of the application roller 16 whereby the neighboring circumferential surface is kept free of adhesive 21. This allows for the application of an open-pore or air-permeable coating structure to the substrate web 19. It is preferable to adjust the rotation speed of the counterpressure roller 17 such as to be equal to that of the application roller 16 such that the coating of the substrate web 19 essentially comprises the structure 43 of the application roller 16.

The doctor blade adjustment shown in FIG. 3 is preferred for thermoplastic adhesives and PUR (polyurethane) adhesives that can be either highly viscous or of low viscosity.

FIG. 4 shows the dosing device 14 in a different position as compared to FIG. 2. FIG. 5 shows the magnified view of detail Y from FIG. 4 in which the positioning of the doctor blade 36 is evident more clearly. The doctor blade 36 is arranged in a negative position. A kind of cuffing arrangement is provided thereby which facilitates that the adhesive 21 remains in the structure 43 of the application roller 16, whereas the neighboring circumferential wall of the application roller 16 is kept free of adhesive 21. This position is preferably selected for PUR adhesives, in particular low viscosity PUR adhesives.

FIG. 6 shows another positioning of the dosing device 14 in which the at least one further area 37 is allocated to the dosing gap 28. Detail Z according to FIG. 6 is shown magnified in FIG. 7. This arrangement provides for an adhesive film corresponding to the dimension of the adjusted dosing gap 28 being dispensed onto which is superimposed the structure 43 of the application roller 16. Therefore, a full-surface coating with a dot-shaped structure on its upper side is applied to the substrate web 19.

When the application roller 16 and the counter roller 17 have the same rotation speed, this structure of the adhesive 21 on the substrate web 19 is preserved. By means of a difference in speed between the counterpressure roller 17 and the application roller 16, with the speed of the counterpressure roller 17 being higher, at least the structure 43 of the adhesive 21 formed by the application roller 16 is smoothed. The larger the difference in speeds, the smoother will be the structure. In addition, this may provide for a reduction in the thickness of the adhesive layer.

FIG. 8 shows another arrangement of the device according to the invention 26 and dosing device 14. The substrate web 19 is supplied to the gap between the application roller 16 and the counterpressure roller 17 at least by means of a guiding roller 49. This guiding roller 49 can provide for the substrate web 19 to rest on the application roller 16 before it is supplied to the gap between the application roller 16 and the counterpressure roller 17. This arrangement is used in particular for highly structured materials. It provides for coating of one side of the substrate web 19 by adhesive 21 and the counterpressure roller 17 can be adjusted with respect to the gap with respect to the application roller 16 such that there is no bleed-through of the adhesive to the counterpressure roller.

FIG. 9 shows in an exemplary fashion a section of a doctor blade 36 that comprises a structured wiper edge 42, for example a row of teeth whose geometry, shape, and depth of the teeth is provided according to choice. Alternatively, the invention can provide for the doctor blade to comprise a continuous wiper edge at least over sections thereof.

The dosing device 14 can be adjusted for different adhesives and application structures by rotation about its longitudinal axis 32. In addition, the use of different doctor blades 36 and/or different positioning thereof allows various application structures to be applied to the application roller 16, which, as before, can be varied as a function of the driving speeds of the application roller 16 and counterpressure roller 17.

Moreover, the dosing device 14 can comprise areas in which segments differing in surface structure can be inserted. For example, without exchanging the dosing device 14, an area 37 can be replaced by another area 37 in that the further area 37 is not applied directly to the body 31 of the dosing device 14, but rather are taken up by the body 31 in a replaceable fashion by means of segments. The segments can be connected by neighboring clamping devices. Circular segments of this type can be provided in the form of so-called stereotypes such that rapid re-assembly is feasible by producing multiple types of stereotypes. These stereotypes can extend over the entire length of the dosing device 14 or consist of multiple elements.

Alternatively, similar or similarly suitable elements can be provided to be detachable from the body 31 of the dosing device 14 in place of a doctor blade 36.

The features described above can be combined in any fashion and each are essential for the invention.

1. Dosing device that is arranged on an application roller such that between the two an adhesive sump is provided, and that is to be arranged at a desired distance from the application roller for adjustment of the width of the dosing gap, and that comprises multiple areas that differ from each other and optionally are directed and arranged towards the application roller in order to create the dosing gap jointly with this application roller.

2. Dosing device according to claim 1, characterized in that the areas that differ from each other are selected by rotating the dosing device and are oriented towards the application roller.

3. Dosing device according to claim 1, characterized in that at least one of the areas comprises a doctor blade as active part.

4. Dosing device according to claim 1, characterized in that at least one further area is provided as external surface area.

5. Dosing device according to claim 1, characterized in that the edge of the doctor blades, the external surface area, and the surface of the application roller are optionally provided to be smooth or structured.

6. Dosing device according to claim 1, characterized in that the rotation speeds of application roller and counterpressure roller are adjusted to be equal or unequal.

7. Dosing device according to claim 1, characterized in that the selected areas of the dosing device are arranged towards the application roller by means of a mechanical or electrical controller device.

8. Dosing device according to claim 1, characterized in that a temperature-controlled facility is arranged inside, outside or inside and outside of a roller-shaped body of the dosing device.

9. Dosing device according to claim 1, characterized in that, upstream of the application roller in the supply direction of the substrate web, a guiding roller is allocated that is provided for the adjustment of an arc of contact of a substrate web to the application roller.

10. Dosing device according to claim 4, characterized in that the external surface area is part of a roller wall section.

11. Dosing device according to claim 3, characterized in that the doctor blades are adjusted to a dosing gap width.

12. Dosing device according to claim 3, characterized in that the doctor blades are directed at a right angle or at an angle larger or smaller than 90° with respect to the circumferential surface of the application roller.

13. Dosing device according to claim 3, characterized in that the doctor blades are connected to the body by means of a rapidly detachable connection, in particular by means of a lever-actuated eccentric clamp.

14. Dosing device according to claim 1, characterized in that its different areas are evenly distributed over its circumference.

15. Dosing device according to claim 3, characterized in that an angle position of the doctor blade is adjustable by means of a rapidly detachable connection.

16. Dosing device according to claim 3, characterized in that a set angle of the doctor blades are adjusted either in a mechanical or electrical fashion.

17. Device for the application of adhesives to one or more substrate webs, in particular for laminating,
with an application roller comprising a smooth or structured surface;
with a dosing device according to any one of the claims 1 to 16 that is allocated to the application roller, and
with a counterpressure roller that carries, opposite to the application roller, a substrate web onto which an application is to be made.
